(19) United States
(12) Patent Application Publication
(10) Pub. No.: US 2005/0086077 A1
(43) Pub. Date: Apr. 21, 2005

(54) Physician workstation computer software program: system and method for making prescription writing and other medical tasks simple and easy

(76) Inventor: Everett Roy Forman, Ballston Lake, NY (US)

Correspondence Address: DAW SYSTEMS, INC., 47 SWEET ROAD, BALLSTON LAKE, NY, 12019, US

(21) Appl. No.: 10/689,120

(22) Filed: Oct. 21, 2003

(51) Int. Cl. G06F 17/60

(52) U.S. Cl. 705/2

(57) ABSTRACT

A physician workstation software program for use by medical professionals to generate prescriptions in one or a combination of outputs: print, fax, and/or e-mail. In addition, users can create disease information sheets, notes, lab test orders, and consultant referrals. The physician workstation software program accesses patient information from a database within the software. A medical professional user can select multiple medications to prescribe. Each medication within the database has pre-programmed formats that can be selected from a “drop-down” window. The physician workstation software program has the ability to print the selected medication to a specified printer, fax or e-mail address Before the electronic prescription is generated in one of the above file outputs, as many as 12 drug checks are performed to ensure accuracy and intent. The software program stores all information done on the system into an internal database for easy recall.

### CROSS-REFERENCE TO RELATED APPLICATIONS

This non-provisional application for patent is being filed within the 12-month pendency period of provisional patent application No. 60/413,870 filed on Oct. 17, 2002. This application intends to benefit from this earlier filing date.

### FIELD OF THE INVENTION

This invention relates to the art of electronic prescription writing through use of a computer or other electronic device.

### BACKGROUND OF THE INVENTION

Many medical professionals in many specialties spend time during their daily routine writing prescriptions. The national average is 2.5 prescriptions per patient. The approximate time to legibly complete a prescription is 30 seconds. This means that anywhere from 1 to 1 ½ minutes is spent on each patient just writing prescriptions. This does not take into account a medical professionals time in researching and determining if the patient has a prior allergy to the medication prescribed, nor does it include time taken out to determine if the prescribed medication will interact with another prescribed medication or current medication the patient takes.

Making the process of prescription writing faster was a definite goal of this invention. Being able to print, fax or e-mail a prescription helps also with legibility and filling of prescription drugs. Sloppily crafted prescriptions can lead to medication filling errors at pharmacies and/or improper taking of medications by patients. This can cause serious harm to patients in the form of allergic reactions, reactions from overdosing, and complications from interacting medications. Added to legibility, was the desire to have automated checking features within the software program to determine accuracy and validity of the prescribed medication; (allergy checking and drug to drug interaction checking). The ultimate goal was to provide an unobtrusive and easy to use software program to medical professionals for the timely completion of accurate, legible and correct prescriptions in the form of printed and/or faxed and/or e-mailed media.

The software program allows for the saving of all information within the database. By saving patient information within a database within the software helps to save the medical professional time as well—alleviating the need to recall a chart to determine past patient medications, diagnoses, and other general medical history. Single-keystroke navigation was integrated into the program so that a single key on a computer keyboard can be used to move through different screens within the software program. All this designed for the easiest and most effective use.

### DESCRIPTION

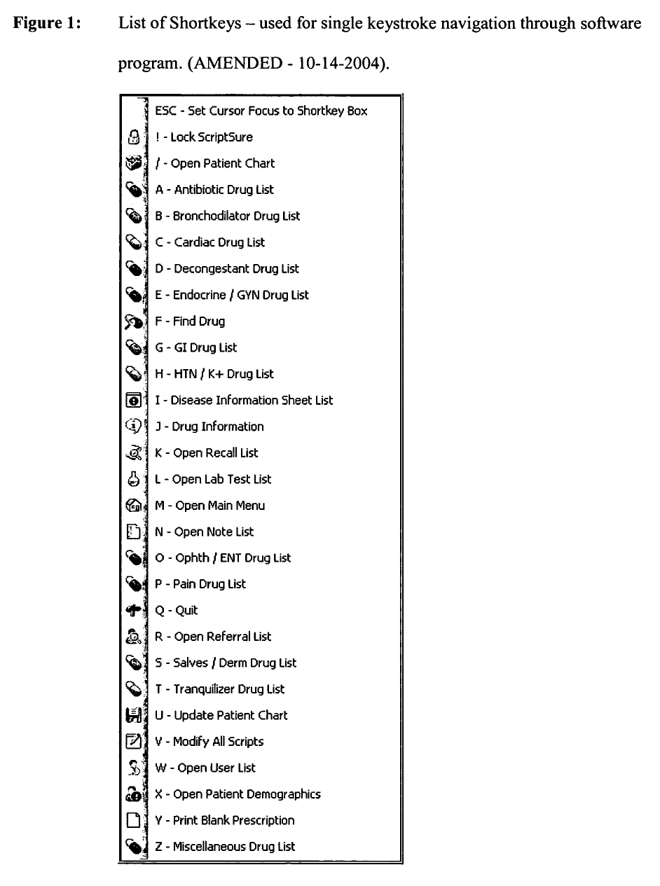

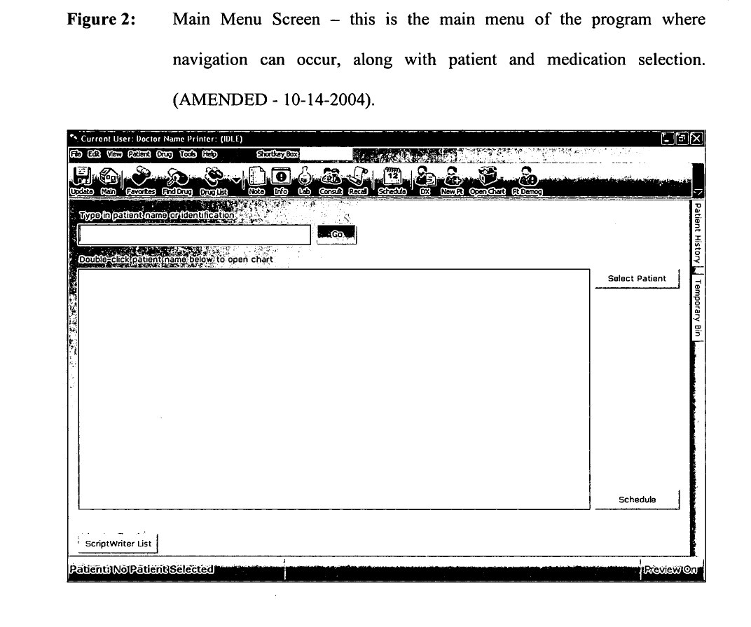

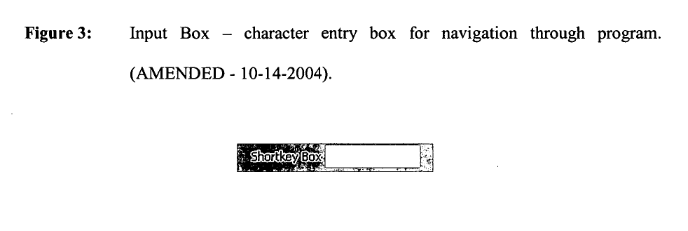

The Windows® based software program is opened in the same way as any other software computer program. By clicking on an icon or program shortcut extension on the computer. Once loaded, there is a password screen that appears. A user will begin by entering their password in the user login window. Once access has been granted, the program opens to the main menu screen. The program was designed to be as easy to use as possible. To that end, single-keystroke navigation in the form of Shortkeys (see FIG. 1—list of Shortkeys) was integrated into the program. In addition, on-screen buttons and a computer mouse/touchscreen can be used for moving through the different screens and features of the program. The Shortkeys that offer single-keystroke navigation can be used interchangeably with the on-screen buttons (see FIG. 2—Main Screen buttons). Shortkeys can be entered in an input box (see FIG. 3—input box) that appears on every screen within the program. For example, by entering the letter “L” in the input box, the program will open the Lab Test Screen. The software automatically disables the single-keystroke navigation feature while a text-entry box has been selected by the user, to prevent navigation when only text-typing is intended.

Primarily, the program is a prescription writer. Prescriptions can be written in several ways. Each of the pre-programmed medications has a number assigned to it. A drug can be prescribed by either entering the number associated with that drug in the input box or double left-clicking with the mouse on the drug. Additionally, prescriptions can be printed by right-clicking on a drug with the mouse key. A drop-down box will appear with nearly all possible drug formats for that specific drug. A single left-click on the desired format will print the drug in a predetermined default, or commonly used, format.

The program contains a feature that allows for a user to customize a drug's format and save that drug format in a specific patient's record in the program. This is very useful if a patient requires a specific (not typical) drug format. This specific drug format can be entered and then saved within the program and easily recalled and prescribed again at a later date by simply clicking an on-screen button.

When a prescription is selected, the program performs multiple checks of that medication to help a user be sure that the medication prescribed is the correct one for the patient. First, the program will automatically check to be sure the patient is not ALLERGIC to the prescribed medication, or an element or compound within the medication being prescribed. The program does this by warning a user (i.e. physician, pharmacist) that a medication considered for treatment may or does cause an allergic reaction to the intended user of the medication. The software program will identify any medications that may have a similar allergic affect to a previously identified allergy causing medication. The methodology employed to determine this is a cross-reference of the allergy causing medication with a compiled list of related allergy medications, compounds of medications and elements. The allergy causing medication is found in a medication database and all medications that have similar properties, chemical structures and ingredients that can cause a similar allergic affect have been linked to the allergy causing medication.

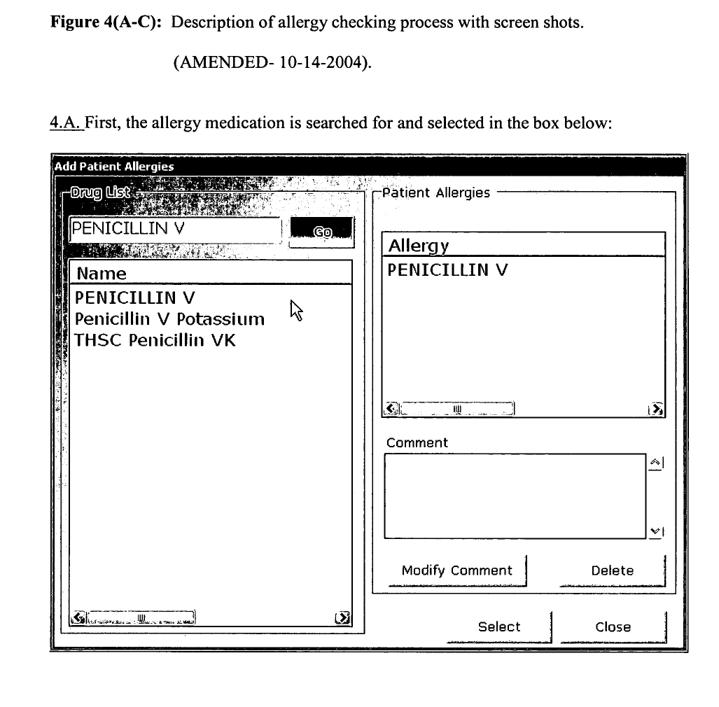

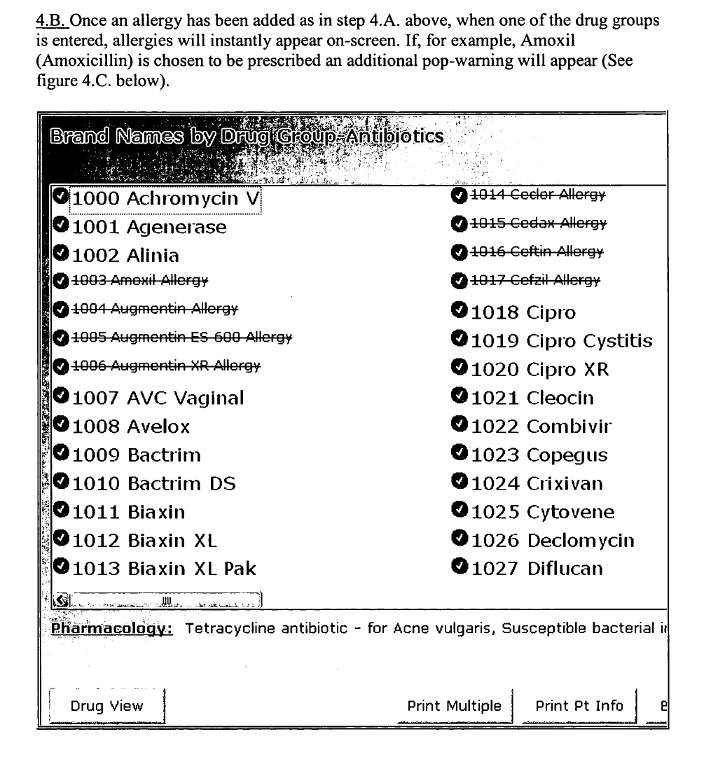

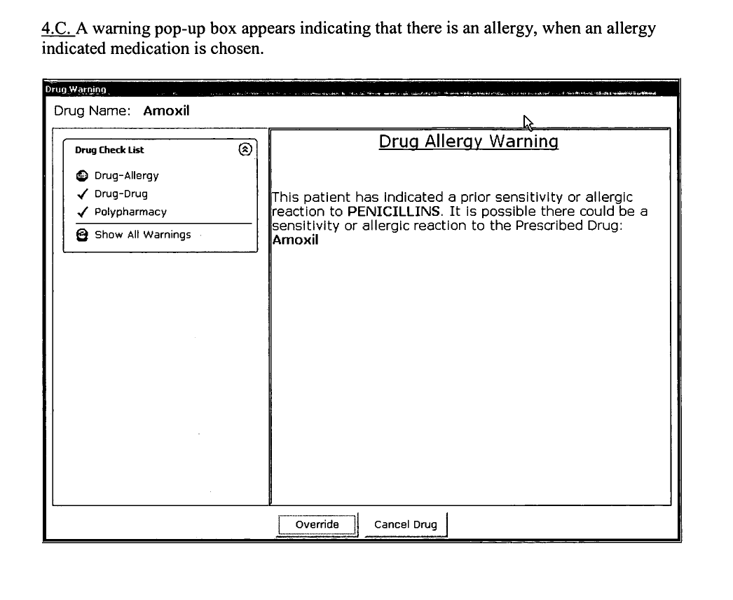

For example, if a patient has an allergy to the medication Penicillin V, then this will be entered into the software program. If a physician attempts to prescribe Amoxil (a medication containing Penicillin) from within the software program, then the software program will warn the physician that the Amoxil is a potential allergy causing medication for the patient (see FIG. 4—allergy application). If the patient does not have any known allergies, this check will not be performed.

The program can also check to be sure that the chosen drug is within the insurance company's current drug formulary (drugs that will be paid for under the insurance company's insurance policy). When a patient is entered in the program, their insurance provider is entered into the system. The drugs that are allowed, not allowed, and allowed but not preferred are differentiated on screen by different color bullets or dice (a green bullet for allowed, a red for allowed but not preferred and a red X for not allowed—alternatively, different numbered dice are used). While the status of the drugs is apparent on-screen, the user will also be warned of the status of the drug after it is chosen for prescribing. A warning will pop-up when the drug is allowed, but not preferred or not allowed and ask the user if he/she wishes to override the warning and still print the drug. If the “check non-drug formulary” feature is not activated within the setup menu, this check will not be performed. An additional feature allows a user to toggle between a view of all the drugs and only those that are allowed—removing the potential to prescribe a drug that is not allowed.

The program will then check to be sure that there is not an INTERACTION between 2 or more drugs that the patient is currently taking or that are currently being prescribed for the patient. This is done by cross-checking the interactions of each drug prescribed. If the same interaction chemical or chemical property is in each drugs interaction information field, then an interaction warning will appear.

For example, if Achromycin V is prescribed and then Amoxil is prescribed, the program will look at the interactions of both the drugs and warn the user, as these are drugs that interact. The interaction information is derived from the drug database and can be viewed on-screen by entering the drug information window. Five different tolerances (levels of interaction) can be checked. If a user would want any remote interaction to be checked, then the user would select the “any tolerance” setting under the setup menu. If the user would only like the program to check for severe interactions, then the user would select severe interaction. If a tolerance level is not selected within the setup menu, this check will not be performed. Also, if only one drug is selected to be printed, the check will not be performed.

In addition to being able to write prescriptions with the program, a user can print notes. The program is delivered with pre-programmed notes, but an unlimited number of custom notes can easily be created. The user needs to only click on the desired note and fill in some information and the note will be print. Both disease information sheets (describing a disease or conditions symptoms, treatment advice and causes for concern in lay language) and drug information sheets (describing a medications properties, ingredients and use in lay language) are pre-programmed into the program as well. Both types of information sheets can be printed by clicking on the list of information sheets. The information database has been pre-programmed and can be modified by the user. New information sheets can be added and saved to the program database as well. Referrals to specialists and consultants can be written from within the program on the referral screen. A specialists name and address can be entered and saved based on the specialists field of practice (i.e. cardiology) and easily recalled. Lab tests can written from within the program. There are many pre-programmed lab tests that can be chosen from the lab test screen. An unlimited number of lab tests can added. A user can select a lab test and then enter a diagnosis specific to that lab test or specific to the lab test series and print the lab test and diagnosis together. This is very helpful as many insurance companies require a distinct diagnosis for a particular ordered lab test.

A summary sheet is printed whenever a patient visit is concluded on the program. It lists all the activities performed for that patient (i.e. lists the drugs prescriptions written, etc.). This summary is also saved to the patient's electronic file within the programs database. The saved information can later be accessed by the user and reviewed in the form of a printed reports or statistical reports of those activities.

As many medical practice professionals perform the same activities repeatedly, the program includes a feature that allows the user to perform several activities by entering only one number or clicking a single button. These are called ScriptWriters. For example, a user can setup a scriptwriter to print 2 drugs, a disease information sheet, a work excuse note and a summary sheet.

The program also has a feature that allows a user to change the color of the drug names in the drug group screens, so that they are more noticeable. If a doctor likes Amoxil for example and would like to have it appear as a different color and bolded for easy recognition, this can be done. Simply highlight the drug to be changed and click the FONT button that appears on every drug group screen. The result is a customized on-screen look.

Inter-office e-mail and messaging as well as recall messaging has been integrated into the system.

1. A computer software program for use by medical professionals at the point of care that executes a method to produce accurate and legible prescriptions.

2. A method of claim 1, wherein the method further comprises the step of: locating within a patient demographic database stored within the software program's files, a patient record.

3. A method of claim 2, wherein the method further comprises the step of: selecting a medication from a medical database stored within the software program's files, and then selecting a format for the prescription to be filled by a pharmacist.

4. A method of claim 3, wherein the method further comprises the step of: once a medication is selected, the software program checks any known allergies of a patient. This is done by retrieving information form within the patient demographic file within the software program and cross-referencing that information with that of the chosen medication. If a prior sensitivity of a patient has been indicated within the software program in the past, then the software program searches each “element” of the indicated sensitivity (i.e. penicillin). In the event that penicillin is found to be an element within a prescribed mediation, then a warning will appear on screen alerting the medical professional user as to the prior indicated allergy.

5. A method of claim 4, wherein the method further comprises the step of: once a medication is selected, the software program checks any all previously prescribed medications within the system and cross-references these medications with the currently prescribed medication to determine if there is a level of interaction that has been indicated by other users in the field of medicine and pharmaceuticals to ensure safe use. If a previously prescribed medication has an interaction that has been indicated in the past with a currently prescribed medication, then the medical professional user will be alerted to this interaction and told the level of interaction; from high to low. This is done by cross-referencing “elements” and/or compounds of a medication against another medications “elements” and/or compounds.

6. A method of claim 5, wherein the method further comprises the step of: printing a prescription; transmitting via fax a prescription; transmitting via e-mail a prescription.

7. A method of claim 6, wherein the method further comprises the step of: updating the information within the software program's patient information so that information can be easily retrieved, reviewed and worked with.

8. A method of navigation throughout the software program, whereby a single key-stroke on a computer keyboard in an “input box” on screen can move the medical professional user between screens and functionality of the program.

9. A method of producing printed reports of patient information and activities performed with the software program for information or archive purposes.

10. A method of refilling medications within a patient's electronic record within the software program. This is done by selecting a patient by any identifying characteristic (name, address, DOB, Social Security number, etc.) and entering the patient's electronic computer file and viewing on-screen the activities, including past medications in precise written format. These formats can be selected with a computer cursor, mouse or keystroke in a “Input Box” within the program.
